(19) United States
(12) Patent Application Publication
(10) Pub. No.: US 2025/0083174 A1
(43) Pub. Date: Mar. 13, 2025

(54) DISPENSING SYSTEM FOR A FOAMING CLEANING FORMULATION

(71) Applicant: The Clorox Company, Oakland, CA (US)

(72) Inventors: Heather DAY, Pleasanton, CA (US); Li ZHANG, Pleasanton, CA (US); Benjamin MA, Pleasanton, CA (US)

(21) Appl. No.: 18/466,311

(22) Filed: Sep. 13, 2023

(51) Int. Cl. B05B 15/63; B05B 12/16; C11D 1/835; C11D 3/20; C11D 3/33; C11D 3/43; C11D 3/50; C11D 11/00; C11D 17/00

(52) U.S. Cl. CPC B05B 15/63; B05B 12/16; C11D 1/835; C11D 3/2086; C11D 3/33; C11D 3/43; C11D 3/50; C11D 17/0043; C11D 1/62; C11D 1/662; C11D 2111/14

(57) ABSTRACT

Systems and methods for dispensing a foaming cleaning formulation. The system includes a foaming formulation and a continuous spray (extended spray) dispensing device, such as a FLAIROSOL dispensing device. The foaming formulation includes a first nonionic surfactant, a second nonionic surfactant (e.g., which may be an amphoteric surfactant) and a C₈ quaternary amine cationic surfactant. The device includes a trigger with a particular spring force, as well as a dispensing orifice with a particular orifice diameter and is used for dispensing the foaming formulation as a foam with an extended spray time, and a controlled drainage rate.

### CROSS REFERENCE TO RELATED APPLICATIONS

N/A.

### BACKGROUND OF THE INVENTION

### 1. The Field of the Invention

The present invention relates to systems and methods of dispensing a foaming cleaning formulation. Disclosed systems include a foaming formulation made with a combination of nonionic and cationic surfactants and a device to dispense the composition with an extended spray time, in a way that delivers the initially unfoamed composition, as a foam. Such a composition effectively cleans bathroom soil.

### 2. Description of Related Art

Currently, trigger sprays, aerosols, and wipes are existing dispensing methods used for bathroom cleaning formulations. While wipes are easy to use, they provide single use cleaning and therefore produce a significant amount of waste, as used wipes are discarded after a single use. Trigger sprays may be used for multiple cleanings, however, currently, they do not enable traditional cleaning formulations to foam during dispensing. While some specialized trigger sprayers may include a mesh foaming trigger (e.g., including a mesh screen in the nozzle) to cause foaming during dispensing, such as used in CLOROX DISINFECTING BATHROOM CLEANING and CLOROX BLEACH FOAMER, such formulations will not foam if dispensed through a sustained release hand-held sprayer, such as FLAIROSOL. It is apparent that a special collection of features are required in order to achieve foaming of a given cleaning composition, through a spray dispenser.

Aerosol dispensers are able to produce foam from traditional cleaning formulations, however, aerosols use propellants, which are known to be environmentally harmful. Additionally, aerosols can be inconsistent in how they dispense a given formulation at the “top” of the can versus the “bottom” of the can. For example, as a traditional aerosol dispensing can is emptied the pressure in the can and the amount of propellant decreases which alters how the formulation is dispensed over the life of the product. Examples of current aerosol formulas with propellants include SCRUBBING BUBBLES BATHROOM GRIME FIGHTER, SCRUBBING BUBBLES MEGA FOAMER, and LYSOL POWER FOAM.

There is thus a continuing need for a hard surface cleaning formulation that will foam using a non-aerosol delivery package, but with the cleaning ease and other ease of use benefits of an aerosol device, as compared to standard trigger sprayer devices. One of the problems with using standard trigger sprayers is that a user's hand may become fatigued when they are repeatedly pulling the trigger many times in order to cover a relatively larger area with the treatment composition. For large bathroom surfaces which may include many vertical surfaces that are more difficult to cover, a trigger sprayer can be difficult to use due to trigger fatigue and inconsistent surface coverage.

### BRIEF SUMMARY

The present invention relates to systems and methods for dispensing a foaming cleaning formulation on a surface. The system includes a foaming formulation that comprises two nonionic surfactants and one cationic surfactant. Additionally, the system includes a device for dispensing the foaming formulation. The formulation may advantageously be stored within the dispensing device reservoir in an unfoamed configuration, but foams upon delivery through the nozzle of the dispensing device. In an embodiment, no mesh foaming trigger with a mesh screen in the nozzle is required to achieve such. It is not common to be able to generate a foaming product without using a mesh screen in the dispensing orifice. In an embodiment, the device dispenses the foaming formulation as a foam with an extended spray time using a trigger, such as a FLAIROSOL type dispenser. It is important to note that a standard, as commercially available, FLAIROSOL trigger sprayer will not generate the desired foam with the formulations described herein. Rather, the FLAIROSOL trigger dispensing orifice size and the spring force had to be modified in order to be capable of generating a foam upon dispensing. FLAIROSOL or similar dispensers are non-pressurized (in that they do not include a pressurized propellant), continuous sprayer type devices. Non-limiting examples of such devices are disclosed in U.S. Pat. Nos. 8,905,271; 9,714,133; 10,456,798; 10,562,053; and 11,660,624, each of which is herein incorporated by reference in its entirety. Such continuous spray devices differ from typical trigger spray devices in that actuation of the trigger builds up pressure within a pressure reservoir of the device, and a substantially continuous pressure is applied to the formulation as it is dispensed, rather than direct application of the pressure to the formulation, as occurs within a conventional trigger spray device, which causes wild fluctuations in pressure applied to the formulation, during dispensing. Such devices also differ from conventional pressurized aerosol dispenser devices, that rely on a pressurized propellant packaged within the aerosol dispensing device, which is used to deliver the formulation from the aerosol dispenser. Such aerosol dispensers are notorious for delivering wildly different particle size distribution characteristics depending on whether the aerosol can is nearly full (i.e., top of the can) versus nearly empty (i.e., bottom of the can). In addition, the compressed gas propellants employed, particularly those that provide the best dispensing characteristics, are environmental pollutants, and therefore their use is undesirable. Such a continuous spray device (like a FLAIROSOL) represents a particularly advantageous device for use in dispensing the device. That said, it will be appreciated that other dispensing devices may alternatively be paired with the presently described compositions, for dispensing a cleaning composition that is initially unfoamed in the reservoir, but is dispensed in a foamed configuration.

Disclosed embodiments are particularly advantageous in providing a consistent foam that adheres to a vertical surface with an efficient drainage rate. For example, foam that is too thick will stay in contact with such a vertical surface indefinitely, and result in inefficient interactions with the soil (e.g., where the active cleaning agents within the composition are held up above the soil, rather than making good contact with the soil, to affect its removal). On the other hand, if a given dispensed foam collapses too quickly, the foam will not adhere to any significant extent to a vertical surface, but will drain off such surface very quickly, also resulting in inefficient interactions with the soil to be removed. What is desired is a balance between foam contact with a vertical surface while also draining at an appropriate but delayed rate, allowing the composition to have sufficient residence time on the vertical surface to interact with and remove the soil being cleaned.

The present invention discloses a system and method for dispensing a foaming cleaning formulation that fills the need for a foaming hard-surface cleaning composition that exhibits similar ease and efficacy to an aerosol system, but without the environmentally negative impacts that come from propellant based aerosol systems.

An exemplary embodiment is directed to a system for dispensing a foaming cleaning formulation. The systems includes a foaming formulation and a device. The foaming formulation includes a first nonionic surfactant, a second nonionic surfactant and a C₈ quaternary amine cationic surfactant. The device includes a trigger and is used for dispensing the foaming formulation as a foam with an extended spray time (e.g., using a continuous spray device such as a FLAIROSOL). It is worth noting that the same formulation, without the C8 quaternary amine cationic surfactant does not reliably generate the desired foam. Nor does use of a similar quaternary amine cationic surfactant, but with a longer alkyl chain (e.g., C12, C14, or C16) reliably generate the desired foam. Similarly, dispensing of the formulation without the described modifications to the orifice size and spring force also do not result in generation of the desired foam. The present disclosure thus requires a relatively specific system, with the particularly described formulation components, and a spray dispenser device with the particularly described mechanical characteristics, to reliably generate the desired foam.

Another embodiment is directed to a system for dispensing a foaming cleaning formulation. The systems includes a foaming formulation and a device. The foaming formulation includes a first nonionic surfactant, a second nonionic surfactant, a C₈ quaternary amine cationic surfactant, at least one of a buffer, a solvent, a fragrance, or a chelator, where the formulation includes at least 90% by weight of water. The device includes a trigger with a spring force from about 30 N to about 60 N. The dispensing device also includes an orifice size of about 0.2 mm to about 0.6 mm, or from 0.25 mm to about 0.5 mm. Applicant has found that there is a relationship between the spring force associated with the trigger, the orifice size, and the composition including nonionic surfactants, and the C8 cationic surfactant, in order to achieve the desired foaming of the formulation during dispensing. For example, where one or more of such features are not provided (e.g., elimination of the recited orifice size, changing the spring force of the trigger, or elimination of the C8 cationic surfactant), foaming may not be consistently achieved. The device is used for dispensing the foaming formulation as a foam with an extended spray time (e.g., using a continuous spray device such as a FLAIROSOL).

Another embodiment is directed to a method for dispensing a foaming cleaning formulation. The method includes providing a foaming formulation in a device configured to dispense the foaming formulation as a foam, wherein the foaming formulation includes a first nonionic surfactant, a second nonionic surfactant, and a C₈ quaternary amine cationic surfactant. The method further includes dispensing the foaming formulation from the device, wherein the device includes a trigger with a particular orifice size and the device is configured to create a foam when sprayed on a wall from a distance of about 6 inches to about 8 inches. The sprayed foam can have an initial diameter on the wall of from about 2 cm to about 10 cm, from about 2 cm to about 6 cm, from about 2.5 cm to about 5 cm, or from about 3 cm to about 4.5 cm and can have a drainage rate of from about 0.5 cm/s to about 3 cm/s, or from about 1 cm/s to about 2 cm/s, or from about 1.25 cm/s to 1.5 cm/s.

In an embodiment, the formulation further includes a chelator.

In an embodiment, the formulation further includes a fragrance.

In an embodiment, the formulation further includes a buffer.

In an embodiment, the formulation further includes a solvent.

In an embodiment, the formulation further includes water. By way of example, a typical formulation may include at least 80%, at least 85%, at least 90%, at least 95%, at least 96%, at least 97%, at least 98%, or at least 99% water.

In an embodiment, the dispensing device has an orifice size from about 0.2 mm to about 0.6 mm, from about 0.25 mm to about 0.5 mm, such as from about 0.28 mm to about 0.42 mm.

In an embodiment, the trigger has a spring force that is less than about 65N. For example, the spring force may be from about 30 N to about 60 N.

In an embodiment, the trigger has a spring force from about 30 N to about 50 N (e.g., 32 N, 36 N, 50 N, or the like). A lower spring force value may be easier on the hand of the user.

In an embodiment, the foaming formulation has a pH from about 10 to about 12.

In an embodiment, the pH is from about 10.5 to about 11.5.

In an embodiment, the C₈ quaternary amine is an alkyl benzyl ammonium chloride (e.g., an alkyl dimethyl benzyl ammonium chloride). The alkyl chain is a C8. In an embodiment, longer alkyl chain ammonium chlorides may be substantially or entirely absent. In an embodiment, a small amount of a longer alkyl chain ammonium chloride may be added, e.g., as an antimicrobial agent.

In an embodiment, the foaming formulation further includes at least one of a buffer, a solvent, a fragrance, or a chelator.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIG. 1 shows an example of a vertically oriented target used in experiments to measure properties of the foam produced by exemplary disclosed embodiments.

FIG. 2 shows experimental results of an exemplary device dispensing a foam onto the target of FIG. 1, immediately after a first spray from the device.

FIG. 3 shows experimental results of the exemplary device dispensing foam on a target after a second spray from the device, and where the foam has begun to drain away from the center of the target, at a given drainage rate.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

The formulation as described herein can be configured to provide sanitization, disinfection, or sterilization, other cleaning, or other treatment. As used herein, the term “sanitize” shall mean the reduction of “target” contaminants in the inanimate environment to levels considered safe according to public health ordinance, or that reduces a “target” bacterial population by significant numbers where public health requirements have not been established. By way of example, an at least 99% reduction in bacterial population within a 24-hour time period is deemed “significant.” Greater levels of reduction (e.g., 99.9%, 99.99%, etc.) are possible, as are faster treatment times (e.g., within 10 minutes, within 5 minutes, within 4 minutes, within 3 minutes, within 2 minutes, or within 1 minute), when sanitizing or disinfecting.

As used herein, the term “disinfect” shall mean the elimination of many or all “target” pathogenic microorganisms on surfaces with the exception of bacterial endospores.

As used herein, the term “sterilize” shall mean the complete elimination or destruction of all forms of “target” microbial life and which is authorized under the applicable regulatory laws to make legal claims as a “sterilant” or to have sterilizing properties or qualities.

Sanitization, disinfection, or sterilization may require the addition of an agent to the formulation, to specifically provide such function. Embodiments as described that include only the nonionic surfactants, and the C₈ quaternary amine surfactant, without the specific addition of a sanitizing or disinfecting agent may not achieve sanitization or disinfection. For example, a C12-C16 quaternary amine sanitizing or disinfecting agent could be added, to achieve such results.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

Reference to ASTM or other standardized tests refers to the latest version of such standard, unless otherwise specified. Standards referenced herein are herein incorporated by reference in their entirety.

### II. Exemplary Foaming Formulation

In an aspect, the present invention is directed to a system for dispensing a foaming cleaning formulation. The system is particularly advantageous in that it dispenses a foam cleaner without the use of pressurized aerosol devices that use a environmentally harmful propellant. Rather, the system may simply employ a continuous spray device, such as available from FLAIROSOL, with some particular modifications to the system, and selections relative to the composition, to ensure that the cleaning formulation foams during delivery. In particular, the formulation foams when being dispensed from a continuous spray non-aerosol device while also providing meaningful benefits to the consumer, such as soap scum removal and a delivery of a balanced foam that does not drain off a vertical surface to be cleaned, too quickly. More particularly, the foam created by the system adheres to a vertical surface as a substantially stable foam while maintaining a relatively slow drainage rate. Disclosed embodiments create a balance between the airy or fluffy foamed consistency and drainage rate. In more detail, if the foam collapses too quickly, or drains too fast, the foam fails to properly adhere to a vertical surface and make efficient contact with soil, therefore decreasing cleaning efficiency. On the other hand, if the foam is too stable, the formula fails to drain and sits above the soil, rather than making effective contact with the soil, which also results in decreased the cleaning efficiency. It is therefore advantageous to provide a delivery device and associated formulation that when used together, provide for a foam that balances these characteristics, of a controlled drainage rate that allows the formulation to provide good contact with the soil, for effective removal.

a. Cationic Surfactant

The formulation includes a cationic surfactant. Exemplary cationic surfactants are quaternary ammonium compounds, such as an alkyl benzyl ammonium chloride. An exemplary alkyl benzyl ammonium chloride may include two relatively shorter alkyl chains (e.g., C₁-C₄, or C₁-C₂) on the quaternary nitrogen, with a longer alkyl chain, e.g., including a C₈ alkyl group (i.e., a C₈ benzyl dialkyl ammonium chloride). For example, an example may include an alkyl benzyl dimethyl ammonium chloride, where the alkyl group is C₈. Another example may include an alkyl benzyl diethyl ammonium chloride, where the alkyl group is C₈. More generally speaking, somewhat longer or shorter alkyl groups may be possible, for example, such as C₆ to C₁₀. That said, Applicant has found that the quaternary ammonium compound having a C₈ alkyl chain is particularly effective at providing a formulation boosts the foaming profile of the formula beyond what can be accomplished by simply increasing the concentration of the included nonionic surfactants. For example, typically, to make a formulation foam in a non-aerosol dispensing device, the formulation requires very high concentrations of surfactants and solvents, which is cost ineffective or exceeds the VOC regulatory limits for the an all-purpose cleaner. For example, foaming formulations as dispensed through a trigger dispenser including a mesh screen in the nozzle will typically require far more than 1% surfactant (e.g., greater than 3%, 5%, or even 10% surfactant). Such formulations are of course relatively expensive. The ability to provide a system that provides reliable dispensing of foam with significantly lower surfactant levels is surprising, unexpected and advantageous. A C₈ quaternary amine cationic surfactant in particular was found by Applicant to surprisingly boost the foaming profile of the formula without increasing the total amount of surfactant present, allowing creating of a foaming formulation that does not rely on dispensing through an aerosol dispensing device, and while meeting the regulatory VOC limits for the formulation.

By way of example, the cationic surfactant may be included in an amount of at least 0.01%, at least 0.05%, at least 0.1%, at least 0.25% no more than 5%, no more than 3%, no more than 2%, no more than 1%, such as 0.01% to 5%, 0.05% to 3%, 0.1% to 2%, 0.1% to 1%, or 0.25% to 1% by weight of the composition.

b. Nonionic Surfactant

In addition to the cationic surfactant, the formulation includes at least one nonionic surfactant, and advantageously, may include two nonionic surfactants. In an embodiment, one of the nonionic surfactants may be an amphoteric or zwitterionic surfactant. Examples of nonionic surfactants include, but are not limited to, alkylpolysaccharides, alcohol ethoxylates, alcohol propoxylates, other alcohol alkoxylates including fatty (e.g., C₆, C₈, C₁₀, or C₁₂, or higher) alcohols or other constituents that have been alkoxylated to include both ethoxy and propoxy groups (EO-PO surfactants), alkyl phosphine oxides, alkyl glucosides and alkyl pentosides, alkyl glycerol esters, alkyl ethoxylates, and alkyl and alkyl phenol ethoxylates of all types, poly alkoxylated (e.g. ethoxylated or propoxylated) C₆-C₁₂ linear or branched alkyl phenols, C₆-C₂₂ linear or branched aliphatic primary or secondary alcohols, and C₂-C₈ linear or branched aliphatic glycols. Block or random copolymers of C₂-C₆ linear or branched alkylene oxides may also be suitable nonionic surfactants. Capped nonionic surfactants in which the terminal hydroxyl group is replaced by halide; C₁-C₈ linear, branched or cyclic aliphatic ether; C₁-C₈ linear, branched or cyclic aliphatic ester; phenyl, benzyl or C₁-C₄ alkyl aryl ether; or phenyl, benzyl or C₁-C₄ alkyl aryl ester may also be used. Sorbitan esters and ethoxylated sorbitan esters are additional examples of nonionic surfactants. Other nonionic surfactants may include mono or polyalkoxylated amides of the formula R¹CONR²R³ and amines of the formula R¹NR²R³ wherein R¹ is a C₅-C₃₁ linear or branched alkyl group and R² and R³ are C1-C₄ alkyl, C1-C₄ hydroxyalkyl, or alkoxylated with 1-3 moles of linear or branched alkylene oxides. Biosoft 91-6 (Stepan Co.) is an example of an alkyl ethoxylate (or alcohol ethoxylate) having a methylene chain length of C₉ to C₁₁ with an average of 6 moles of ethoxylation. An example of an alcohol ethoxylate is ECOSURF EH-9, which is more specifically an ethylene oxide-propylene oxide copolymer mono(2-ethylhexyl) ether, available from Dow.

Alkylpolysaccharide (e.g., alkylpolyglucoside or alkylpolyglycoside) nonionic surfactants are disclosed in U.S. Pat. No. 4,565,647 to Llenado, having a linear or branched alkyl, alkylphenyl, hydroxyalkyl, or hydroxyalkylphenyl group containing from 6 to 30 carbon atoms and a polysaccharide, e.g., a polyglycoside, hydrophilic group containing from 1.3 to 10 saccharide units. Suitable saccharides may include, but are not limited to, glucosides, galactosides, lactosides, and fructosides. Alkylpolyglycosides may have the formula: R²O(CnH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 10.

Fatty acid saccharide esters and alkoxylated fatty acid saccharide esters are additional examples of nonionic surfactants. Examples include, but are not limited to, sucrose esters, such as sucrose cocoate, and sorbitan esters, such as polyoxyethylene(20) sorbitan monooleate and polyoxyethylene(20) sorbitan monolaurate.

Phosphate ester surfactants are another example of nonionic surfactants. These include mono, di, and tri esters of phosphoric acid with C₄-C₁₈ alkyl, aryl, alkylaryl, alkyl ether, aryl ether and alkylaryl ether alcohols (e.g. disodium octyl phosphate).

By way of example, the nonionic surfactant may be included in an amount of at least 0.01%, at least 0.05%, at least 0.1%, at least 0.25% no more than 5%, no more than 3%, no more than 2%, no more than 1%, such as 0.01% to 5%, 0.05% to 3%, 0.1% to 2%, 0.1% to 1%, or 0.25% to 1% by weight of the composition. Such values may be for an individual non-ionic surfactant, or collectively, where two nonionic surfactants are included.

c. Other Surfactants

In an embodiment, the composition includes a zwitterionic or amphoteric surfactant. Zwitterionic or amphoteric surfactants include both a positive and negative functional group, and may therefore also be classified as nonionic surfactants. In an embodiment, where two nonionic surfactants are included, one of the included nonionic surfactants may in fact be an amphoteric surfactant. Many such amphoteric or zwitterionic surfactants contain nitrogen. Examples of such include amine oxides including amido amine oxides (such as an amidopropyl amine oxides), sarcosinates, taurates and betaines. Examples include C₈-C₁₈ alkyldimethyl amine oxides (e.g., octyldimethylamine oxide, lauryldimethylamine oxide (also known as lauramine oxide), and cetyldimethylamine oxide), C₄-C₁₆ dialkylmethylamine oxides (e.g. didecylmethyl-amine oxide), C₈-C₁₈ alkyl morpholine oxide (e.g. laurylmorpholine oxide), lauryl and/or myristyl amidopropyl amine oxide, tetra-alkyl diamine dioxides (e.g. tetramethyl hexane diamine dioxide, lauryl trimethyl propane diamine dioxide), C₈-C₁₈ alkyl betaines (e.g. decylbetaine and cetylbetaine), C₈-C₁₈ acyl sarcosinates (e.g. sodium lauroylsarcosinate), C₈-C₁₈ acyl C₁-C₆ alkyl taurates (e.g. sodium cocoylmethyltaurate), C₈-C₁₈ alkyliminodipropionates (e.g. sodium lauryliminodipropionate), and combinations thereof. Lauryl dimethyl amine oxide (Ammonyx LO) myristyl dimethyl amine oxide (Ammonyx MO), decylamine oxide (Ammonyx DO) and lauryl/myristyl amidopropyl amine oxide (Ammonyx LMDO) are examples of zwitterionic amine oxide surfactants, available from Stepan Co.

By way of example, an amphoteric or zwitterionic surfactant may be included in an amount of at least 0.01%, at least 0.05%, at least 0.1%, at least 0.25% no more than 5%, no more than 3%, no more than 2%, no more than 1%, such as 0.01% to 5%, 0.05% to 3%, 0.1% to 2%, 0.1% to 1%, or 0.25% to 1% by weight of the composition. Where both a nonionic surfactant (e.g., alkyl polyglucoside) is included in combination with an amphoteric surfactant (e.g., an amidopropyl amine oxide), each surfactant may be included in any of the noted amounts (e.g., 0.01% to 5%, 0.05% to 3%, 0.1% to 2%, 0.1% to 1%, or 0.25% to 1% by weight of each of the nonionic surfactant, and the amphoteric surfactant, individually).

Some embodiments may include, or exclude an anionic surfactant. Non-limiting examples of anionic surfactants that may be included or excluded include sulfates, sulfonates, alkyl sulfates (e.g., C₈-C₁₈ or C₈-C₁₂ linear or branched alkyl sulfates such as sodium lauryl sulfate (SLS), sodium n-octyl sulfate and sodium tetradecylsulfate), alkyl sulfonates (e.g., C₆-C₁₈ or C₈-C₁₂) linear or branched alkyl sulfonates such as sodium octane sulfonate and secondary alkane sulfonates, alkyl ethoxysulfates, fatty acids and fatty acid sulfate or sulfonate salts (e.g., C₆-C₁₆ fatty acid soaps such as sodium laurate), and alkyl amino acid derivatives. Other examples may include sulfate derivatives of alkyl ethoxylate propoxylates, alkyl ethoxylate sulfates, alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methylsulfonates, C₆-C₁₈ alkyl, aryl, or alkylaryl ether carboxylates, sulfonated alkyldiphenyloxides (e.g. sodium dodecyldiphenyloxide disulfonate), and the like.

Where included, an anionic surfactant may be included in an amount of at least 0.01%, at least 0.05%, at least 0.1%, at least 0.25% no more than 5%, no more than 3%, no more than 2%, no more than 1%, such as 0.01% to 5%, 0.05% to 3%, 0.1% to 2%, 0.1% to 1%, or 0.25% to 1% by weight of the composition.

Various surfactants and other optional adjuvants are disclosed in U.S. Pat. No. 3,929,678 to Laughlin and Heuring, U.S. Pat. No. 4,259,217 to Murphy, U.S. Pat. No. 5,776,872 to Giret et al.; U.S. Pat. No. 5,883,059 to Furman et al.; U.S. Pat. No. 5,883,062 to Addison et al.; U.S. Pat. No. 5,906,973 to Ouzounis et al.; U.S. Pat. No. 4,565,647 to Llenado, and U.S. Publication No. 2013/0028990. The above patents and applications are each herein incorporated by reference in their entirety.

Total surfactant concentration may be at least 0.25%, at least 0.5%, at least 1%, at least 2% no more than 10%, no more than 5%, no more than 4%, no more than 3%, such as 0.25% to 10%, 0.5% to 5%, 1% to 5%, 1% to 4%, or 1% to 3% by weight of the composition.

The ratio of the nonionic and/or amphoteric surfactants to the cationic surfactant may be 1:1 to 10:1, or 1:1 to 8:1 1.5:1 to 5:1, such as 2:1 to 5:1.

d. Solvents

In an embodiment, the only solvent separately added to the composition is water. Water may typically comprise the majority of the formulation, e.g., accounting for at least 50%, at least 60%, at least 70%, at least 80%, at least 90%, or at least 95% by weight of the formulation. Even concentrated formulations, intended for dilution by the user prior to dispensing a foamed form of the composition, may include significant water content (e.g., at least 10%, at least 20%, at least 30% or more). In an embodiment, water may be included in amounts to bring the weight percentage to 100% based on the other components described above.

In some embodiments, the pH of the formulation is from about 8 to about 13, from about 9 to about 12, or from about 10.5 to about 11.5.

While in an embodiment, the only separately added solvent is water (e.g., apart from solvents that may be present within a fragrance, or other additive, which may itself include a solvent), in other embodiments, additional solvents may be present. Non-limiting examples of additional solvents that could be included include glycol ethers. Exemplary glycol ether solvents include, but are not limited to, ethylene glycol monopropyl ether, ethylene glycol monobutyl ether, ethylene glycol monohexyl ether, ethylene glycol phenyl ether, propylene glycol n-propyl ether, propylene glycol monobutyl ether, propylene glycol t-butyl ether, diethylene glycol monoethyl or monopropyl or monobutyl ether, di- or tri-polypropylene glycol methyl or ethyl or propyl or butyl ether, tripropylene glycol n-butyl ether (TPnB), diethylene glycol monohexyl ether, propylene glycol phenyl ether (PPh), acetate and/or propionate esters of glycol ethers. Other solvents, particularly naturally sourced or derived solvents, are also possible. Where present, additional solvents may be included in amounts of at least 0.01%, at least 0.05%, at least 0.1%, in amounts of at least 0.25%, up to 5%, up to 4%, up to 3%, up to 2%, or up to 1% by weight of the cleaning composition. While both lower alcohols (e.g., C₁-C₄ alcohols) and higher chain length alcohols (e.g., C₈ and higher, such as C₆ to C₁₆, C₈ to C₁₂, C₁₀, etc.) may sometimes be used as solvents, their absence or substantial absence (particularly lower alcohols) can be beneficial in minimizing the presence of VOC components, as well as for other reasons. If present, the amount of such volatile solvents may be limited, e.g., to less than 5%, less than 3%, less than 2%, less than 1%, less than 0.5%, less than 0.3%, less than 0.2%, less than 0.1%, less than 0.05%, or less than 0.01% by weight.

e. Other Adjuvants

In some example embodiments, the formulation optionally includes one or more adjuvants. Examples of such include pH adjusters, additional solvents, fragrances or perfumes, dyes and/or colorants, builders, defoamers, thickeners, hydrotropes, antimicrobial agents, preservatives, solubilizing materials, stabilizers, lotions and/or mineral oils, enzymes, cloud point modifiers and mixtures or combinations thereof.

Examples of buffers include carbonates, silicates, and citric acid or citrates. Citric acid is also an exemplary pH adjustor. When included as a buffer or pH adjustor, the citric acid is present at a concentration that is lower than would be required to achieve sanitization and/or disinfection (e.g., no more than 0.1%, or no more than 0.05%, or no more than 0.03%).

In some example embodiments, the formulation optionally includes at least one of a salt or a chelator. Chelating agents in particular are able to remove or sequester divalent cations (e.g., Ca²⁺, Mg²⁺, etc.). Non-limiting examples of possible chelators include aminocarboxylate salts, such as salts (e.g., a trisodium salt) of methylglycinediacetic acid (MGDA), salts (e.g., a tetra sodium salt) of glutamic acid diacetic acid (GLDA), salts (e.g., a trisodium salt) of alanine, N,N-bis(carboxymethyl), sodium citrate, glucaric acid or salts thereof, glutamic acid or salts thereof, N,N-diacetic acid or salts thereof, tetra sodium salts, EDTA salts, tartaric acid or salts thereof, fluconic acid or salts thereof, tricaballyic acid or salts thereof, acetic acid or salts thereof, citric acid or salts thereof, or combinations thereof. In embodiments containing the salt, the salt may comprise a potassium salt, such as potassium chloride or potassium EDTA.

Any such additional adjuvants may be present individually or collectively in amounts of less than 3%, less than 2%, less than 1%, less than 0.8%, less than 0.5%, less than 0.3%, less than 0.2%, less than 0.1%, less than 0.05% or less than 0.01%.

The formulations prior to foaming may be of relatively low viscosity (e.g., less than 1000 cps, less than 500 cps, or less than 100 cps, such as from 1 cps to 1000 cps, or 1 cps to 100 cps).

### Dispensing Device

As mentioned above, traditional foaming formulations are dispensed using an aerosol type device. However, aerosols introduce environmental hazards as well as being inconsistent in delivery throughout the lifetime of the product (i.e., delivery characteristics can be wildly different at the “top” of the aerosol can, as compared to delivery at the “bottom” of the aerosol can). In addition, other sprayer devices traditionally fail to create stable foam, with an appropriate, balanced drain rate.

Disclosed embodiments use a device with a trigger to produce a foam from the above disclosed foaming formulation. In particular, the device is configured to dispense the foaming formulation as a foam with an extended spray time (e.g., known in the field as a continuous spray device), as opposed to a conventional trigger spray bottle device.

In particular, in an embodiment, the device is a non-pressurized, continuous sprayer type device, such as those available under the tradename FLAIROSOL. Non-limiting general examples of such devices are disclosed in U.S. Pat. No. 8,905,271 to Maas et al.; U.S. Pat. No. 11,660,624 to Maas et al.; U.S. Pat. No. 10,456,798 to Maas et al.; U.S. Pat. No. 10,562,053 to Maas et al.; and U.S. Pat. No. 9,714,133 to Maas et al., each of which is herein incorporated by reference in its entirety. Such continuous spray devices differ from typical trigger spray devices in that actuation of the trigger builds up pressure within a pressure reservoir of the device, and a substantially continuous pressure is applied to the formulation as it is dispensed, rather than direct application of the pressure to the formulation, with each squeeze of the trigger, as occurs within a conventional trigger spray device, which causes wild fluctuations in pressure applied to the formulation, during dispensing. In addition to using such a continuous spray device, specific modifications or selections with respect to spring force of the trigger, and nozzle opening size can be made, to ensure that the composition is consistently delivered as a foam having desired characteristics.

Such devices also differ from conventional pressurized aerosol dispenser devices, that rely on a pressurized propellant packaged within the aerosol dispensing device, which is used to deliver the formulation from the aerosol dispenser. Such aerosol dispensers are notorious for providing wildly different dispensing characteristics depending on whether the aerosol can is nearly full (i.e., top of the can) versus nearly empty (i.e., bottom of the can). In addition, the compressed gas propellants employed, particularly those that provide the best dispensing characteristics, are environmental pollutants, and therefore their use is undesirable.

In some embodiments, the dispensing device is provided with an orifice diameter of from about 0.2 mm to about 0.6 mm, or from about 0.25 mm to about 0.5 mm, or about 0.3 mm to about 0.45 mm. Such an orifice diameter was found to provide consistent foaming of the product during delivery, with a desired drainage rate. For example, it is desired that the foamed composition drain faster than a thick foam like shaving cream, which may not drain to any significant degree within 5 seconds on a vertical surface. On the other hand, the foamed composition is intended to drain more slowly than a thinner foam, or a composition that does not foam at all from such a vertical surface, which does not provide sufficient residence time on the soil on the vertical surface to achieve effective cleaning.

Applicant similarly found that the spring force of the device trigger also affects the quality of the delivered foam, as well as the ease of use on the user's hand, when using such device. By way of example, the spring force may be from about 25 N to about 60 N, from about 30 N to about 50 N, or from about 32 N to about 50 N (e.g., 32 N, 36 N, or 50 N).

In an embodiment, when the dispensing nozzle is held 4-12 inches, 2-10 inches, or 6-8 inches from a vertical surface, the system generates a foam on the vertical surface with an initial diameter on the vertical surface of from about 2 cm to about 10 cm, from about 2 cm to about 6 cm, from about 2.5 cm to about 5 cm, from about 3 cm to about 4.5 cm, or from about 7 cm to about 9 cm. As sprayed on such a vertical surface, in an embodiment, the foam created by the dispensing device has a drainage rate of from about 0.5 cm/s to about 3 cm/s, from about 1 cm/s to about 2 cm/s, or from about 1.25 cm/s to about 1.5 cm/s.

### III. Examples and Data

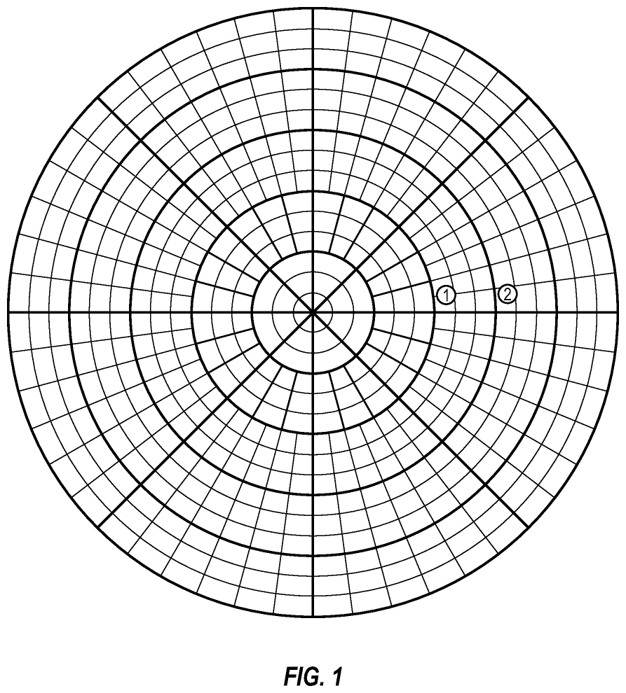

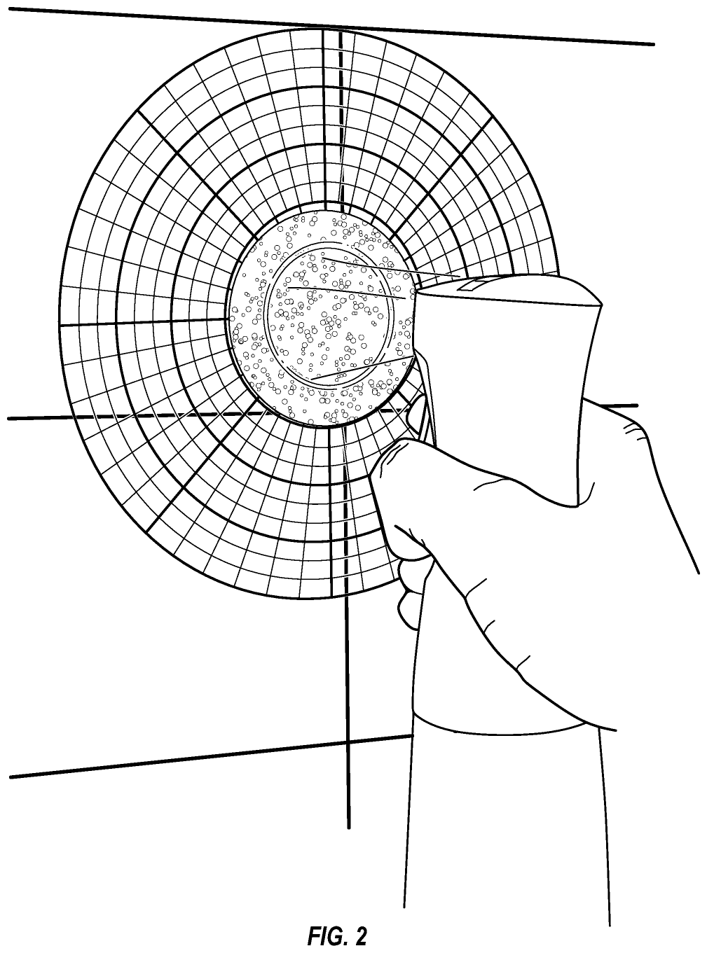

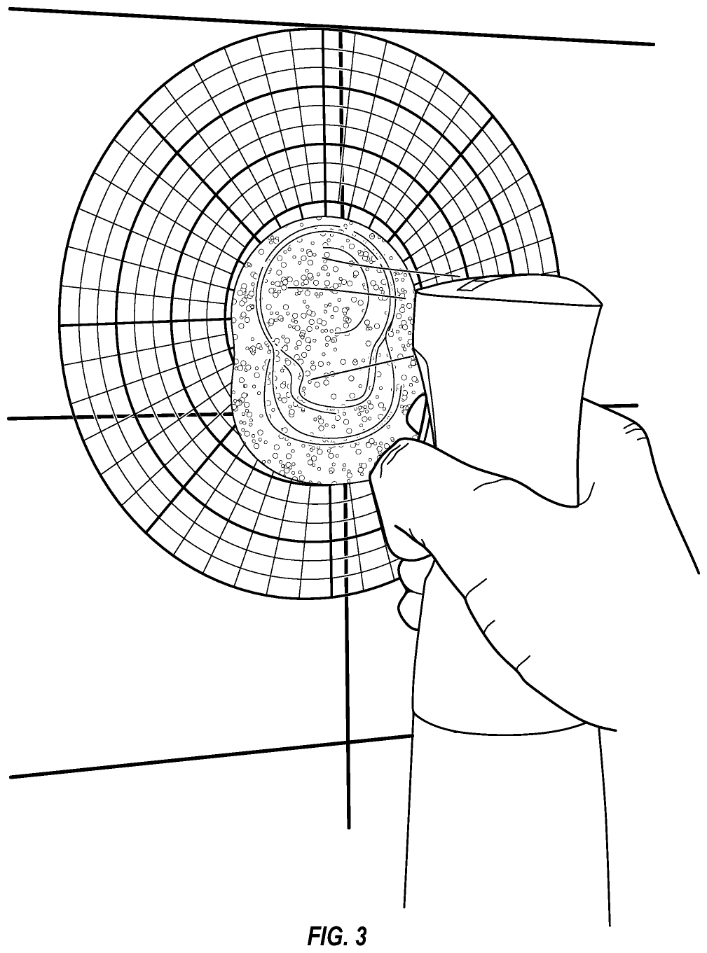

FIG. 1 shows an exemplary target used in experiments, while FIGS. 2 and 3 show spraying of an exemplary foam, and resulting drainage after about 1.25 seconds, respectively (i.e., the time lapse between FIGS. 2 and 3 is about 1.25 seconds).

In more detail, the experiments used a laminated target, as shown in FIG. 1, on an 8.5″ by 11″ sheet of paper, mounted vertically on a bathroom wall. The laminated target was placed on the shower wall, and attached by painters' tape on the top only of the laminated target. The trigger of the FLAIROSOL dispensing device was primed by pulling the trigger until the foaming formulation was dispensed as a spray from the dispensing device (i.e., “first pull”).

The foaming formulation was sprayed from the FLAIROSOL device onto the target from a distance of 6 inches to 8 inches away. The trigger of the device was fully depressed once and the trigger was allowed to completely compress and release. Once the trigger was compressed and released fully, the trigger was pulled a second time (i.e., “second pull”).

To measure the drainage rate, a video of the test is recorded for the entire process. A stopwatch was started when the first spray started, and was stopped once the product had drained to the bottom of the laminated target. The diameter of the sprayed foam when first hitting the target was also measured, as capturing on the recorded video. These data allow calculation of the drainage rate, and direct measurement (via the video) of the initial spray diameter.

In the experiments a FLAIROSOL device with a modified trigger and orifice diameter was used. Springs in the trigger having a spring force of 32 N and 50 N were used. Orifice diameters of 0.28 mm, 0.34 mm, and 0.42 mm were used. The foaming formulation had a composition shown below in Table 1.

TABLE 1

| | RM % Active | Formulation % | Active Wt. % |
|---|---|---|---|
| Citric Acid | 50 | 0.01-0.1% | 0.005-0.05% |
| Ammonyx LMDO | 33 | 0.9-4.5% | 0.3-1.5% |
| Alkylpolyglucoside | 50 | 1-6% | 0.5-3% |
| potassium EDTA | 45 | 0.55-6.7% | 0.25-3% |
| C₈ quaternary amine | 60 | 0.4-3.3% | 0.25-2% |
| Fragrance | 100 | 0.05-0.5% | 0.05-0.5% |
| Water | — | 79-97% | 79-97% |

FIG. 2 shows the foaming formulation dispensed as a foam on the laminated target after a single priming spray. As shown, the foam is bounded within the center two circles of the target with a diameter of about 3 cm to about 4.2 cm. A stopwatch was started at the start of the first spray and was allowed to run until the foam reached the bottom of the laminated target to calculate a drainage rate of about 1.25 cm/s to about 1.42 cm/s.

FIG. 3 shows the foamed formulation after dispensing the second spray. As shown, the foam produced from the second spray is still within the center two bold circles of the target, while the foam from the first spray has begun to drain down the laminated target through the third bold circle, and just beginning to enter the 4^{th} bold circle.

As shown in FIGS. 2 and 3, the foam has an airy or fluffy consistency with a retarded drainage rate, characteristic of such a consistency. Qualitatively, the foam advantageously adheres to the vertical surface long enough to make contact with soil, for effective soil removal, but is not so thick as to cause the foam to not drain, but sit above the soil. Quantitatively, the airiness of the foam can be seen with a drainage rate of about 1.25-1.42 cm/s. A relatively rapid drainage rate is indicative of a sheer or thin foam, while a relatively long drainage rate is indicative of a thick foam. The present foam is balanced, being thinner than a thick foam (such as shaving cream), but thicker than an unfoamed composition, which exhibits substantially no residence time on the soil before draining.

In addition to working well at removing bathroom scum, and use as an all purpose foamed bathroom cleaner, the foamed formulation was observed to work surprisingly well on glass and mirror surfaces, exhibiting surprisingly low residue.

The foamed formulation was also observed to surprisingly exhibit the ability to remove rust, at high pH (e.g., 10.5 to 11.5), without the need for an abrasive. Rust removal typically requires acidic pH (e.g., pH of 2-3), and/or an abrasive.

Without departing from the spirit and scope of this invention, one of ordinary skill can make various modifications to the invention to adapt it to various usages and conditions. As such, these changes and modifications are properly, equitably, and intended to be, within the full range of equivalence of the following claims.

1. A system for dispensing a foaming cleaning formulation, the system comprising:
(a) a foaming formulation comprising:
(i) a first nonionic surfactant;
(ii) a second nonionic surfactant; and
(iii) a C₈ quaternary amine cationic surfactant;
(b) a device for dispensing the foaming formulation as a foam with an extended spray time, wherein the device includes a trigger.

2. The system of claim 1, wherein the second nonionic surfactant is an amphoteric surfactant.

3. The system of claim 1, wherein the formulation further comprises a fragrance.

4. The system of claim 1, wherein the formulation further comprises at least one of a chelator or buffer.

5. The system of claim 1, wherein the formulation further comprises a solvent.

6. The system of claim 1, wherein the formulation further comprises water.

7. The system of claim 1, wherein the dispensing device has a nozzle orifice size from about 0.2 mm to about 0.6 mm.

8. The system of claim 7, wherein the orifice size is from about 0.25 mm to about 0.5 mm.

9. The system of claim 1, wherein the trigger includes a spring having a spring force from about 30 N to about 60 N.

10. The system of claim 9, wherein the trigger includes a spring having a spring force from about 30 N to about 50 N.

11. The system of claim 1, wherein the foaming formulation has a pH from about 9 to about 12.

12. The system of claim 11, wherein the pH is from about 10.5 to about 11.5.

13. The system of claim 1, wherein the C₈ quaternary amine is an C₈ benzyl dialkyl ammonium chloride.

14. A system for dispensing a foaming cleaning formulation, the system comprising:
(a) a foaming formulation comprising:
(i) a first nonionic surfactant;
(ii) a second nonionic surfactant;
(iii) a C₈ quaternary amine cationic surfactant;
(iv) at least one of a buffer, a solvent, a fragrance, or a chelator; and
(v) at least 90% by weight water;
(b) a device for dispensing the foaming formulation as a foam with an extended spray time, wherein the device includes a trigger having a spring with a spring force from about 30 N to about 60 N and the dispensing device including a nozzle orifice diameter of about 0.2 mm to about 0.6 mm.

15. The system of claim 14, wherein the foaming formulation has a pH from about 9 to about 12.

16. A method of dispensing a foaming cleaning formulation, the method comprising:
providing a foaming formulation in a device configured to dispense the foaming formulation as a foam with an extended spray time, wherein the foaming formulation comprises:
(i) a first nonionic surfactant;
(ii) a second nonionic surfactant; and
(iii) a C₈ quaternary amine cationic surfactant;
dispensing the foaming formulation from the device, wherein the device includes a trigger and a nozzle with an orifice diameter, the device being configured to create a foam when sprayed on a vertical wall from a distance of about 6 inches, the sprayed foam having an initial diameter on the vertical wall of from about 2 cm to about 10 cm, and having a drainage rate of from about 0.5 cm/s to about 3 cm/s.

17. The method of claim 16, wherein the foaming formulation further comprises at least one of a buffer, a solvent, a fragrance, or a chelator.

18. The method of claim 16, wherein the foaming formulation has a pH from about 9 to about 12.

19. The method of claim 16, wherein the orifice diameter is from about 0.2 mm to about 0.6 mm.

20. The method of claim 16, wherein the trigger includes a spring having a spring force from about 30 N to about 50 N.
